(19) United States
(12) Patent Application Publication
(10) Pub. No.: US 2003/0201031 A1
(43) Pub. Date: Oct. 30, 2003

(54) Method of improving toughness of sintered RE-Fe-B-type, rare earth permanent magnets

(75) Inventors: Shiqiang Liu, Dayton, OH (US); Jinfang Liu, Lancaster, PA (US)

Correspondence Address: BANNER & WITCOFF, LTD., 28 STATE STREET, 28th FLOOR, BOSTON, MA, 02109-9601, US

(73) Assignees: Electron Energy Corporation, Landisville, PA (US); University of Dayton, Dayton, OH

(21) Appl. No.: 10/293,680

(22) Filed: Nov. 13, 2002

Related U.S. Application Data
(60) Provisional application No. 60/376,218, filed on Apr. 29, 2002.

(51) Int. Cl. H01F 1/057

(52) U.S. Cl. 148/108

(57) ABSTRACT

Disclosed are methods for producing compositionally modified sintered RE—Fe—B-based rare earth permanent magnets, by the addition of small amounts of Nd, Cu, Ti, Nb, or other transition metals, and mixtures thereof, to maximize fracture toughness with corresponding improved machinability, while maintaining maximum energy product, said method comprising the steps of:

(a) prepare a magnetic composition;

(b) melt the composition and form powders with an average particle size smaller than 5 microns from the same;

(c) press the powder under a magnetic field to obtain green compacts, which are then sintered at from about 1030° C. to 1130° C., and heat treating the sintered material at from about 570° C. to 900° C.

### CROSS-REFERENCE TO RELATED APPLICATION

This application is related to commonly owned, copending application entitled “MODIFIED SINTERED RE—Fe—B-TYPE, RARE EARTH PERMANENT MAGNETS WITH IMPROVED TOUGHNESS,” Ser. No. 10/xxx,xxx, (Attorney Docket No. 4928/00006) filed on even date herewith, the disclosure of which is hereby incorporated herein by reference.

### BACKGROUND OF THE INVENTION

Since their commercial introduction in the mid-1980s, applications for rare earth-iron-boron magnets have continued to grow and this material has become a major factor in the global rare earth permanent magnet market. Among commercially available permanent magnets, Nd₂Fe₁₄B type magnets offer the highest maximum energy product (BH)ₘₐₓ ranging from 26 to 48. Experimental versions have reported a (BH)ₘₐₓ in excess of 55 MGOₑ.

Nd₂Fe₁₄B rare earth magnets exhibit the highest room temperature magnetic properties, which is the basis for the wide use. As noted above, high performance Nd₂Fe₁₄B-based permanent magnets provide high maximum energy products (BH)ₘₐₓ. In addition, they offer large saturation magnetization (4πMs) and high intrinsic coercivity (_{M}H_{C}). That the Nd—Fe—B-type permanent magnets continue to offer the most promise for high magnetic performance rare earth permanent magnets is evident from FIG. 1.

Unfortunately, the Nd₂Fe₁₄B rare earth permanent magnets are notoriously brittle and susceptible to oxidation. Chipping, cracking and fracture often occur during grinding, assembly and even during operation of conventional Nd₂Fe₁₄B magnets. The fact that since these magnets cannot be machined and/or drilled imposes serious limitations on the shapes and uses available. The reject rate in production attributed to brittleness/lack of toughness runs generally from 10 to 20% and, on occasion, reaches 30%. The poor fracture toughness of current rare earth permanent magnets is illustrated in FIG. 2.

All sintered rare earth permanent magnets, SmCo₅, Sm₂CO₁₇, and Nd₂Fe₁₄B, are brittle due to the intrinsically brittle intermetallic compounds used for these magnets. Machinable permanent magnets include:

(a) Fe—Cr—Co-type, which unfortunately exhibit low magnetic-performance,

(b) Pt—Co-type which are too expensive, and

(c) Bonded permanent magnets that exhibit dramatically reduced performance, i.e. loss of up to 50% magnetic performance comparing to their sintered counterparts.

Improvement in the fracture toughness of the class of rare earth permanent magnets of the REFeB-type, while maintaining their high: 4πM_{S}, _{M}H_{C}, and (BH)ₘₐₓ, would not only improve their manufacturing efficiency and machinability, but it would also expand the market for this class of permanent magnets, by offering opportunities for new applications, new shapes, new uses, lower costs, etc.

Relevant prior art in this area includes: U.S. Pat. Nos.: 4,402,770; 4,597,938; 4,710,239; 4,770,723; 4,773,950; 4,859,410; 4,975,130 and 5,110,377. Additional references include: U.S. Pat. Nos. 3,558,372 and 4,533,408. Relevant literature references include:

M. Sagawa, S. Fujimura, N. Togawa, H. Yamamoto, and Y. Matsuura, “New material for permanent magnets on a base of Nd and Fe”, Journal of Applied Physics, volume 55, pp. 2083-2087, 1984;

Y. Kaneko and N. Ishigaki, “Recent developments of high-performance NEOMAX magnets”, JMEPEG, VOLUME 3, PP. 228-233, 1994;

M. Sagawa and H. Nagata, “Novel processing technology for permanent magnets” IEEE Trans. Magn. Volume 29, pp. 2747-2752, 1993;

S. Hirosawa and Y. Kaneko, “Rare earth magnets with high energy products” in Proceedings of the 15^{th} international Workshop on Rare Earth Magnets and Their Applications, volume 1, pp. 43-53, 1998;

M. Takahashi, et al, “High performance Nd—Fe—B sintered magnets made by the wet process”, J. Appl. Phys., volume 83, pp. 6402-6404, 1998;

J. J. Croat, J. F. Hebst, R. W. Lee, and F. E. Pinkerton, “Pr—Fe and Nd—Fe based materials: A new class of high performance permanent magnets”, J. Appl. Phys. Vol. 55, pp. 2078-2082, 1984;

J. F. Herbst, “R2Fe14B materials: Intrinsic properties and technological aspects”, Rev. Mod. Phys. Vol. 63, pp. 819-898, 1991;

Croat et al, “Pr—Fe and Nd—Fe-based Materials: A New Class of High-Performance . . . ”, J. Appl. Phys., 55(6), Mar. 15, 1984;

Sagawa et al, “New Material for Permanent Magnets on a Base of Nd and Fe”, J. Appl. Phys. 55(6), Mar. 15, 1984;

Koon et al, Crystallization of FeB Alloys with . . . ”, J. Appl. Phys. 55(6), Mar. 15, 1984;

Stadelmaier, “The Neodymium-Iron Permanent Magnet Breakthrough”, MMPA Workshop, Jan. 1984;

Japanese High Technology, “Request for New Magnetic Material . . . ”, vol. 4, No. 5, Aug. 1984;

“Neomax-Neodymium-Iron-Magnet”, Sumitomo Special Metals Co., Ltd. Lee, “Hot-Pressed Neodymium-Iron-Boron Magnets”, Appl. Phys. Lett. (46(8) Apr. 15, 1985;

R. K. Mishra, “Microstructure of Melt-Spun Neodymium-Iron-Boron Magnets”, International Conference on Magnetism, 1985;

Sagawa et al., “Permanent Magnet Materials Based on the Rare Earth-Iron-Boron Tetragonal Compounds”, The Research Institute for Iron, Steel and Other Metals, Tohoku University, Japan;

Givord et al., “Magnetic Properties and Crystal Structure of R₂Fe₁₄B”, Solid State Comm., vol. 50. No. 6, Feb., 1984, pp. 497-499;

Herbst et al., “Relationships Between Crystal Structure and Magnetic Properties in R₂Fe₁₄B”, Phys. Dept., General Motors Res. Lab., pp. 1-10; and

Croat et al., “High-Energy Product Nd—Fe—B Permanent Magnets”, App. Phys. Lett., 44(1), Jan. 1, 1984, pp. 148-149.

Various rare earth permanent magnets can be formed by pressing and sintering the powder or by bonding with plastic binders. Sintered Nd₂Fe₁₄B parts produce the highest magnetic properties. Unfortunately, Nd₂Fe₁₄B magnets are sensitive to heat and normally cannot be used in environments that exceed 150° C.

Compared to the SmCo 1:5 and 2:17magnets, Nd₂Fe₁₄B magnets have an excellent value in terms of price per unit of (BH)ₘₐₓ. Small shapes and sizes with high magnetic fields are one of the attractive features of Nd₂Fe₁₄B magnets. Today's commercial Nd₂Fe₁₄B-based magnets include combinations of partial substitutions for Nd and Fe, leading to a wide range of available properties.

Several different techniques are used to produce Nd₂Fe₁₄B-based magnets. One method is similar to that used for ceramic ferrite and sintered Sm—Co magnets. The alloys with appropriate composition are induction melted to ingots, which are then crushed and milled to powders of a few microns. The powder is formed into a desired shape by pressing under alignment field. The pressed green compacts are then sintered to full density and heat treated to obtain suitable magnetic properties.

Second process involves rapid quenching of a molten Nd₂Fe₁₄B-based alloy, using a “melt spinning” technique to produce ribbons, which are then milled to powder. While the crushed ribbon yields relatively large platelet-shaped powder particles, rapid quenching provides them with an extremely fine microstructure having grain boundaries that deviate from the primary Nd₂Fe₁₄B composition. Rapidly quenched powder is inherently isotropic. However, it can be consolidated into a fully dense anisotropic magnet by the plastic deformation that occurs in hot pressing. The fine microstructure also makes this powder very stable against oxidation, making it easy to blend and form into a wide range of isotropic bonded magnets.

Nd₂Fe₁₄B powder tends to readily absorb hydrogen, which degrades the material into a very brittle powder. This response to hydrogen renders the powder more amenable to milling and is the basis for the hydrogenation, disproportionation, desorption and recombination process generally referred to as HDDR. The HDDR process provides Nd₂Fe₁₄B powder with an ultrafine structure with grains about the size of a single domain. Such HDDR powder can be hot pressed into a fully dense anisotropic magnet, or it can be blended and molded into an anisotropic bonded magnet.

### SUMMARY OF THE INVENTION

Disclosed are methods for producing compositionally modified sintered RE—Fe—B-based rare earth permanent magnets, by the addition of small amounts of Nd, Cu, Ti, Nb, or other transition metals, and mixtures thereof, to maximize fracture toughness with corresponding improved machinability, while maintaining maximum energy product, said method comprising the steps of:

(a) prepare a base RE—Fe—B magnetic composition;

(b) add predetermined amounts of elements selected from the group consisting of Nd, Cu, Ti, Nb, other transition metals, and mixtures thereof, to said base magnetic composition;

(c) heat process said magnetic composition into a modified RE—Fe—B-based rare earth permanent magnet.

Thus, one embodiment of the present invention is a method for improving the toughness of sintered RE—Fe—B-type, rare earth permanent magnets comprising the step of varying the Nd content in the magnet composition prior to alloy formation by heating, e.g., in either a vacuum induction melting furnace or a vacuum arc melting furnace. Advantageously, the method of the present invention may also be achieved by adding various amounts of Ti, Nb or Cu to the magnet composition prior to alloy formation. Preferably both methods are employed.

One embodiment of the present invention further comprises a method for improving the fracture toughness of sintered rare earth permanent magnets.

Another embodiment of the present invention comprises a method for improving the fracture toughness and the machinability of sintered rare earth permanent magnets, while maintaining high maximum energy product.

A further embodiment of the present invention comprises a method for compositionally modifying RE—Fe—B-type rare earth permanent magnets to improve fracture toughness, while maintaining high maximum energy product.

More specifically, the improved RE—Fe—B-type rare earth permanent magnets of the present invention can be obtained by modifying the composition thereof with an increase of the Nd level and/or the addition of a small amount of Cu, Ti, Nb, and mixtures thereof. The resulting compositional modifications can be represented by the following:

(a) Nd_{w}Fe_{94-w}B₆, wherein:

w has a value between about 17 and about 22;

(b) Nd₁₆Fe₇₈₋ₓTiₓB₆, wherein:

x has a value between about 0.78 and about 2.34;

(c) Nd₁₆Fe_{78-y}Nb_{y}B₆, wherein:

y has a value between about 1.56 and about 2.34; and

(d) Nd₁₆Fe_{78-z}Cu_{z}B₆, wherein:

z has a value between about 0.78 and about 1.56

It has been found that the compositionally modified sintered RE—Fe—B-type rare earth permanent magnets of the present invention achieve substantial improvement in fracture toughness, i.e., by up to about 76% increase while substantially maintaining maximum energy product.

The present invention will be further described based on the accompanying drawings, which are presented for illustrative purposes only.

### BRIEF DESCRIPTION OF THE DRAWINGS

FIG. 1 schematically illustrates the magnetic performance of seven types of commercial rare earth permanent magnets; shown as a plot of intrinsic coercivity versus maximum energy product for permanent magnets.

FIG. 2 schematically summarizes the poor fracture toughness of three types of commercial rare earth permanent magnets; shown as a plot of fracture toughness versus maximum energy product for permanent magnets.

FIGS. 3a through 3c are illustrative stress-strain curves for different types of materials. Y and T denote yield and tensile strength, respectively. FIG. 3A shows Type I materials; FIG. 3B shows Type II materials; and FIG. 3C shows Type III materials.

FIG. 4 illustrates a Charpy impact testing specimen with specific dimensions.

FIGS. 5 through 8 indicate the effect various levels of Nd, Ti, Nb and Cu, respectively, have on the fracture toughness of various RE—Fe—B-type rare earth permanent magnets.

FIG. 9 compares the fracture toughness of two compositionally modified rare earth permanent magnets of the present invention against two commercial rare earth permanent magnets.

FIG. 10 illustrates how the rare earth permanent magnets of the present invention compare to commercial magnets with respect to fracture toughness; shown as a plot of fracture toughness versus maximum energy product for permanent magnets.

FIGS. 11 through 14 illustrate magnetic properties of various rare earth permanent magnets of the present invention. Although the magnetic properties have not been optimized yet, the trend of property variation versus composition modification can be clearly seen.

FIG. 15 is a SEM micrograph of Nd₁₆Fe_{76.44}Ti_{1.56}B₆ magnets of the invention showing the Nd₂Fe₁₄B main phase and the Ti-rich phase

FIG. 16 shows the sintered NdFeB magnets of the invention were machined by conventional cutting and drilling, which is impossible for commercial sintered NdFeB magnets.

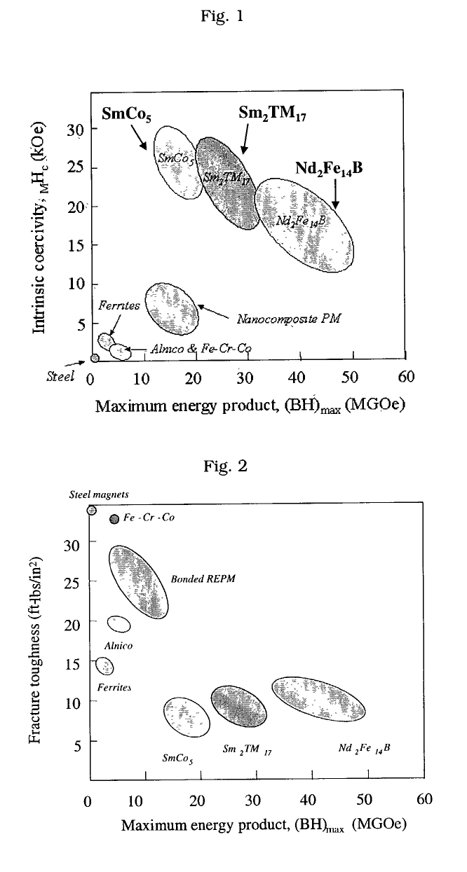

### DETAILED DESCRIPTION OF THE PREFERRED EMBODIMENTS

A material's strength and toughness are different physical parameters. For example, high strength usually does not usually lead to good toughness. More specifically, the toughness of a material is defined as the energy, E, needed to break a material. In a plot of stress vs. strain, this energy is equal to the area under the stress-strain curve.

$$E = {\int }_{0}^{ϵ f} σ d ϵ$$

where ε_{f} is the strain at fracture.

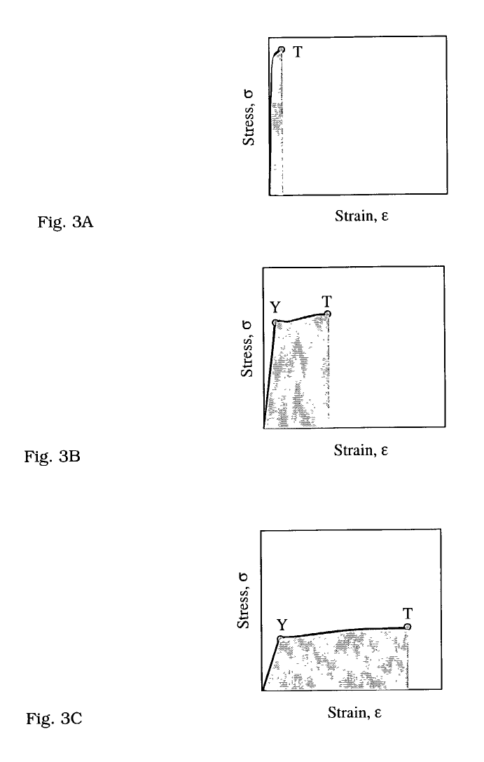

FIGS. 3(a) and 3(b) of the drawings schematically show stress-strain curves of two types of materials. The Type I materials have high strength but poor toughness, while the type II materials have low strength but good toughness. Glass and ceramics are typical Type I materials while soft metals, such as Al and Cu, are typical Type II materials. Type I materials tend to be very hard and brittle, with little or even no plastic deformation occurring before fracturing. On the other hand, Type II materials generally indicate good plasticity with low strength. Their toughness is shown in the area under the stress vs. strain curves in FIGS. 3b and 3c.

Clearly, an increase in strength does not equate to improvement in toughness. More often than not, such an increase in strength would accompany decrease in plasticity, which would lead to decreased toughness. Maximum toughness, therefore, is preferably achieved by optimizing the combination of strength and ductility. In order to obtain a magnet with improved toughness as shown in FIG. 3(c) it has been found preferable to not increase strength, but rather to increase ductility (plasticity). The modified RE—Fe—B-type magnets of the present invention generally achieve this increase in ductility via compositional modification as detailed in Tables 2 through 5 and Examples 2 through 22 below.

It is generally agreed that there are three phases in sintered RE—Fe—B-type rare earth permanent magnets: (1) a RE₂Fe₁₄B phase, (2) a RE-rich grain boundary phase, and (3) a B-rich REFe₄B₄ phase. Surprisingly, it has been discovered that the toughness of the sintered REFeB magnets of the present invention can surprisingly be enhanced dramatically by modifying these three phases through certain unobvious compositional modifications.

According to the process of the present invention, RE—Fe—B-type magnets were compositionally modified by varying Nd content and/or by adding Ti, Nb or Cu to the alloys described below by mixing appropriate quantities of different alloys as detailed below:

TABLE 1

| Alloys Prepared by Using a | Alloys prepared by Using |
|---|---|
| aVacuum Induction Melting Furnace | Vacuum Arc Melting Furnace |
| Nd₁₆Fe₇₈B₆ | Nd₁₆Fe₇₈B₆ |
| Nd₆₀Fe₃₄B₆ | Nd₆₀Fe₃₄B₆ |
| Nd₁₅Dy₁Fe₇₈B₆ | Nd₁₆Fe₃₉Ti₃₉B₆ |
| Nd_{2.4}Pr_{5.6}Dy₁Fe₈₅B₆ | Nd₁₆Fe₃₉Nb₃₉B₆ |
| | Nd₁₆Fe₃₉Cu₃₉B₆ |

The Group #1 and #2 alloys described below were prepared using conventional powder metallurgy, without adjusting parameters to optimize magnetic properties. Each was prepared following the steps set out below:

Step 1—A jaw crusher and a double roller crusher were used to crush the ingot,

Step 2—Ball milling was used to reduce the crushed particles to ˜5 μm powder,

Step 3—This ˜5 μm powder was compacted using an isostatic press at 3 ton/cm³,

Step 4—The compacted powder was sintered at 1080° C. for 20 minutes in a high vacuum followed by exposure to Ar for 40 minutes, and

Step 5—The sintered magnet underwent post sintering heat treatment at 650° C. for 20 minutes.

Group #1 alloys include:

Nd₁₆Fe₇₈B₆

Nd₁₇Fe₇₇B₆

Nd₁₈Fe₇₆B₆

Nd₁₉Fe₇₅B₆

Nd₂₀Fe₇₄B₆

Nd₂₁Fe₇₃B₆

Nd₂₂Fe₇₂B₆

Nd₂₃Fe₇₁B₆

Nd₁₆Dy₁Fe₇₈B₆

Group #2 alloys include:

Nd₁₆(Fe₁₋ₓ)₇₈B₆ with x=0.01, 0.02, 0.03, and 0.04

Nd₁₆Fe_{77.22}Ti_{0.78}B₆

Nd₁₆Fe_{76.44}Ti_{1.56}B₆

Nd₁₆Fe_{75.66}Ti_{2.34}B₆

Nd₁₆Fe_{74.88}Ti_{3.12}B₆

Nd₁₆(Fe₁₋ₓNbₓ)₇₈B₆ with x=0.01, 0.02, 0.03, and 0.04

Nd₁₆Fe_{77.22}Nb_{0.78}B₆

Nd₁₆Fe_{76.44}Nb_{1.56}B₆

Nd₁₆Fe_{75.66}Nb_{2.34}B₆

Nd₁₆Fe_{74.88}Nb_{3.12}B₆

Nd₁₆(Fe₁₋ₓCuₓ)₇₈B₆ with x=0.01, 0.02, 0.03, and 0.04

Nd₁₆Fe_{77.22}Cui_{0.78}B₆

Nd₁₆Fe_{76.44}Cu_{1.56}B₆

Nd₁₆Fe_{75.66}Cu_{2.34}B₆

Nd₁₆Fe_{74.88}Cu_{3.12}B₆

Examples of four such modifications and the unexpected and surprising fracture toughness results associated with these modifications are detailed below:

(1) The effect of Nd content on the toughness of sintered RE—Fe—B-type rare earth permanent magnets of the invention is set out in Table 2 and FIG. 5.

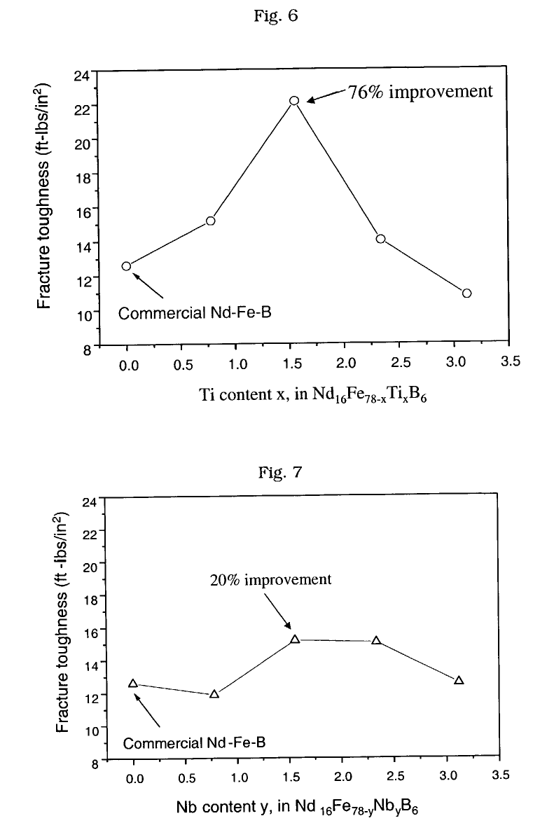

(2) The effect of Ti addition on the toughness of sintered RE—Fe—B-type rare earth permanent magnets of the invention is set out in Table 3 and FIG. 6.

(3) The effect of Nb addition on the toughness of sintered RE—Fe—B-type rare earth permanent magnets of the invention is set out in Table 4 and FIG. 7.

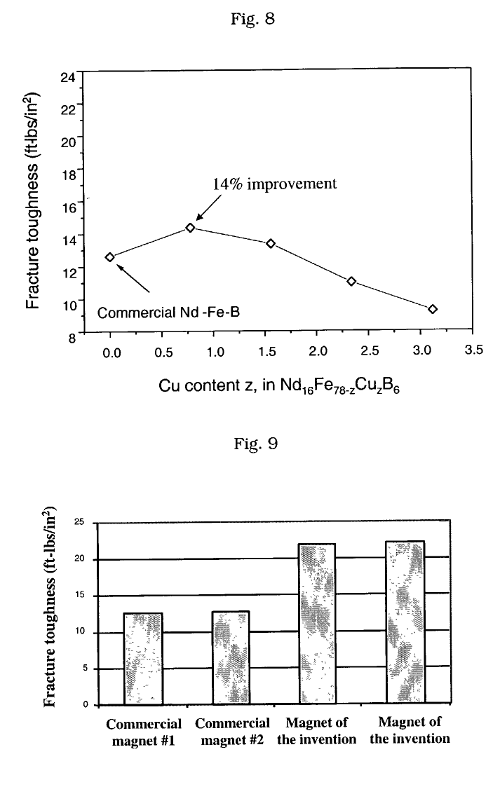

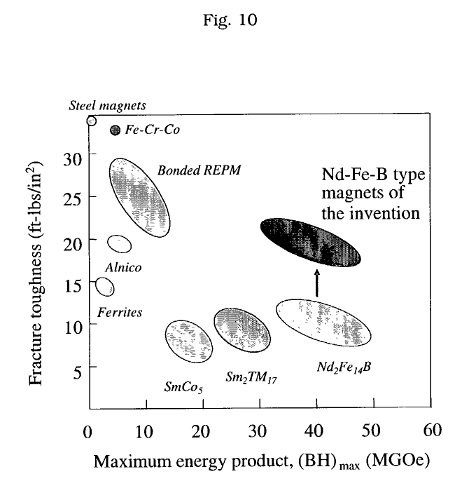

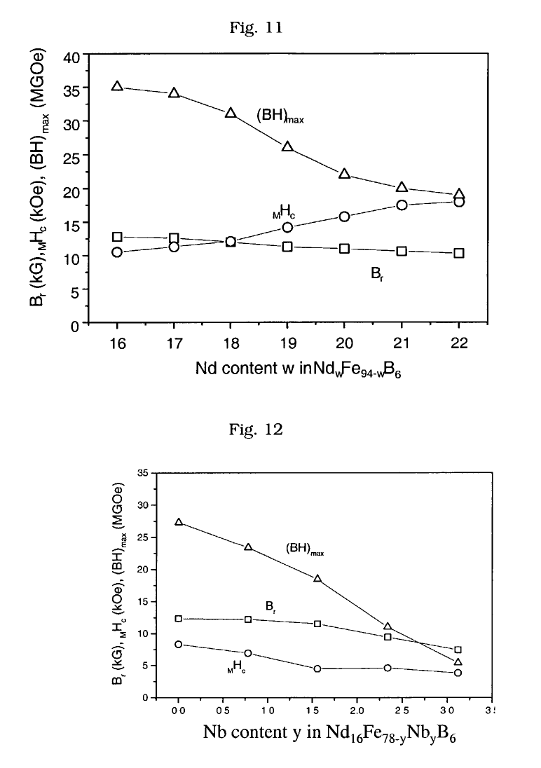

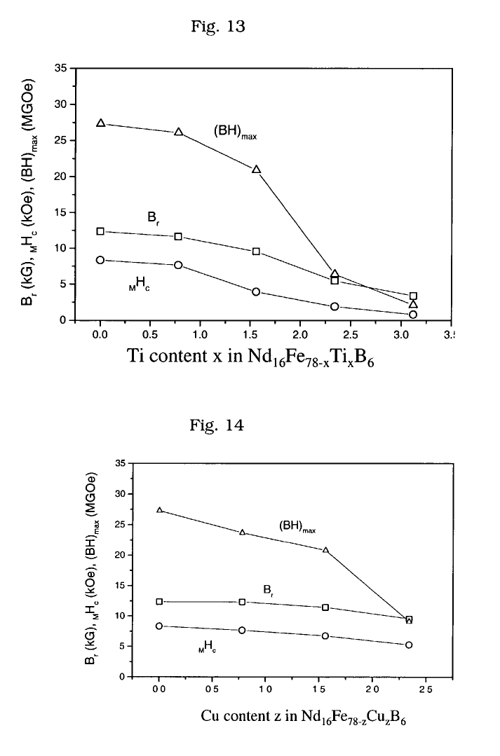

(4) The effect of Cu addition on the toughness of sintered RE—Fe—B-type rare earth permanent magnets of the invention is set out in Table 5 and FIG. 8.

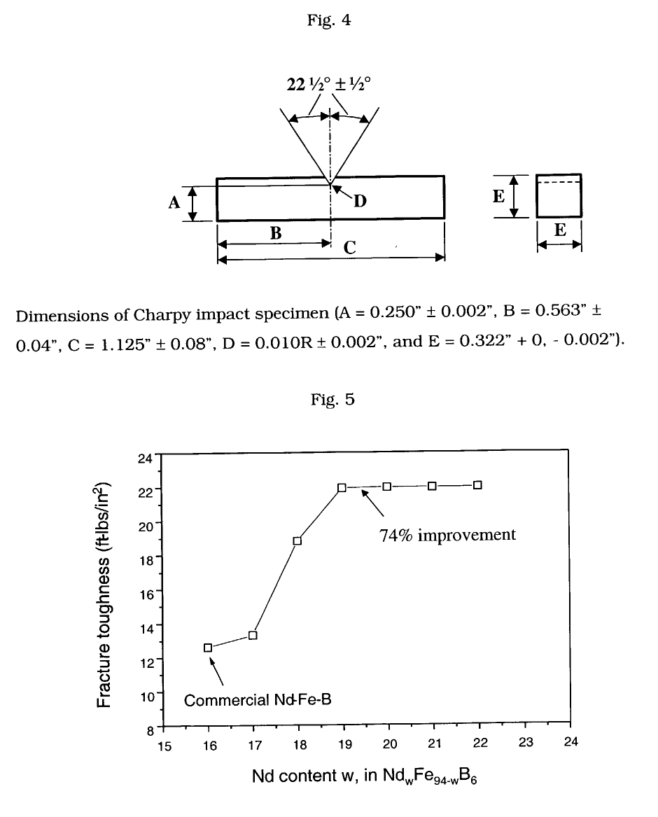

The toughness of the various modified RE—Fe—B-type magnets of the invention was determined at room temperature (20°) using a standard Charpy impact testing method with a Bell Laboratories Type Impact Testing Machine. The energy required to break the impact specimen can be readily determined in the test. For the purposes of the present invention, this energy divided by the area at the notch, is defined as the fracture toughness. Fracture toughness describes the toughness of the material tested, as that term is used throughout this specification. The dimensions of the specimens used are detailed in FIG. 4. The effect of the Nd modification to the composition on the fracture toughness of the sintered REFeB magnets is detailed in Table 2 and FIG. 5.

TABLE 2
Effect of Nd Compositional Modification on the Fracture toughness of Sintered
RE-Fe-B-type Rare Earth Permanent Magnets of the Present Invention

| | | | | Percent Increase | |
|---|---|---|---|---|---|
| | | | Fracture | in Fracture | |
| Example | Specific | Energy Absorbed | toughness | toughness | |
| # | Composition | (ft-lbs) | (ft-lbs/in²) | (in %) | Observation |
| 1* | Nd₁₆Fe₇₈B₆ | 1.0148 | 12.606 | N/A | |
| 2 | Nd₁₇Fe₇₇B₆ | 1.0711 | 13.306 | 6 | |
| 3 | Nd₁₈Fe₇₆B₆ | 1.5150 | 18.820 | 49 | |
| 4 | Nd₁₉Fe₇₆B₆ | 1.7647 | 21.922 | 74 | |
| 7 | Nd₂₀Fe₇₄B₆ | 1.7678 | 21.960 | 74 | |
| 8 | Nd₂₁Fe₇₃B₆ | 1.7678 | 21.960 | 74 | |
| 9 | Nd₂₂Fe₇₂B₆ | 1.7689 | 21.974 | 74 | |

*Example 1 is a commercial Nd-Fe-B magnet used to establish baseline.

It can be seen from Table 2 that the toughness of the various sintered nd—Fe—B-type rare earth permanent magnets is responsive to the Nd content in the magnet alloy. The fracture toughness of Nd₁₆Fe₇₈B₆ is 12.606 ft-lbs/in². This value represents the fracture toughness of typical commercial sintered Nd—Fe—B-type magnets. It is apparent from FIG. 5 that the fracture toughness (toughness) sharply increases by increasing the Nd content up to 19%. Surprisingly, beyond the 19% level, further increases of the Nd content do not appear to materially affect the fracture toughness of the various modified Nd—Fe—B-type magnets.

The fracture toughness of Nd₁₉Fe₇₅B₆ (Example #4), 21.922 ft-lbs/in², is unexpectedly 74% higher than a typical commercial sintered Nd—Fe—B-type magnet represented by Nd₁₆Fe₇₈B₆. Surprisingly such a low Nd level (19%) is required to achieve improved toughness of sintered modified Nd—Fe—B magnets.

Table 3 lists data on the effect of Ti addition on toughness (fracture toughness) for various sintered Nd—Fe—B magnets based on the Charpy impact test. The results are also shown in FIG. 6. It can be seen from FIG. 6 that the toughness of sintered Nd—Fe—B magnets sharply increases by increasing n content. The toughness reaches a peak of 22.124 ft-lbs/in² at 1.56% Ti and then unexpectedly decreases. It should be mentioned that Example #13 (Nd₁₆Fe_{75.66}Ti_{2.34}B₆) was cut with two notches accidentally. Therefore, the fracture toughness value for Example #13 is not accurate and may actually be much higher than reported.

TABLE 3
Effect of Ti Composition Modification on the Fracture toughness of Sintered
RE-Fe-B-type Rare Earth Permanent Magnets of the Invention

| | | | | Increase in | |
|---|---|---|---|---|---|
| | | | Fracture | Fracture | |
| Example | Specific | Energy Absorbed | toughness | toughness | |
| # | Composition | (ft-lbs) | (ft-lbs/in²) | (in %) | Observation |
| 1* | Nd₁₆Fe₇₈B₆ | 1.0148 | 12.606 | N/A | Baseline |
| 11 | Nd₁₆Fe_{77 22}Ti_{0.78}B₆ | 1.2213 | 15.171 | 20 | |
| 12 | Nd₁₆Fe_{76 44}Ti_{1.56}B₆ | 1.7810 | 22.124 | 76 | |
| 13 | Nd₁₆Fe_{75 66}Ti_{2 34}B₆ | 1.1276 | 14.007 | 11 | Double |
| | | | | | notches |
| 14 | Nd₁₆Fe_{74 88}Ti_{3.12}B₆ | 0.8687 | 10.791 | −14 | |

*Example #1 is a commercial Nd-Fe-B magnet.

Similar to Ti, Nb has been observed to be another element useful for grain refinement. The effect of Nb addition on the fracture toughness of various sintered Nd—Fe—B magnets is set out in Table 4 and FIG. 7. It can be concluded from FIG. 7 that the Nb addition also improves toughness of various sintered Nd—Fe—B-type magnets. A peak fracture toughness of 15.171 ft-lbs/in² is reached at 1.56%. Apparently, the effect of Nb on the toughness of various Nd—Fe—B magnets is not as great as Ti.

TABLE 4
Effect of Nb Composition Modification on the Fracture toughness of Sintered
RE-Fe-B-type Rare Earth Permanent Magnets of the Invention

| | | | | Percent Increase | |
|---|---|---|---|---|---|
| | | Energy | Fracture | in Fracture | |
| Example | Specific | Absorbed | toughness | toughness | |
| # | Composition | (ft-lbs) | (ft-lbs/in²) | (in %) | Observation |
| 1* | Nd₁₆Fe₇₈B₆ | 1.0148 | 12.606 | N/A | Baseline |
| 15 | Nd₁₆Fe_{77.22}Nb_{0.78}B₆ | .9572 | 11.891 | −6 | |
| 16 | Nd₁₆Fe_{76.44}Nb_{1 56}B₆ | 1.2213 | 15.171 | 20 | |
| 17 | Nd₁₆Fe_{76 66}Nb_{2 34}B₆ | 1.2112 | 15.046 | 19 | |
| 18 | Nd₁₆Fe_{74 88}Nb_{3.12}B₆ | 1.0098 | 12.544 | 0 | |

*Example #1 is a commercial Nd-Fe-B magnet.

The effect of Cu on room temperature toughness of various sintered Nd—Fe—B magnets is-shown in Table 5 and FIG. 8. It is seen from FIG. 8 that adding Cu to various Nd—Fe—B magnet compositions slightly improves room-temperature toughness of various sintered Nd—Fe—B magnets. Fracture toughness peaks at 14.359 ft-lbs/in² with 0.78% Cu.

TABLE 5
Effect of Cu Composition Modification on the Fracture toughness of Sintered
RE-Fe-B-type Rare Earth Permanent Magnets of the Invention

| | | | | Percent Increase | |
|---|---|---|---|---|---|
| | | Energy | Fracture | in Fracture | |
| Example | | Absorbed | toughness | toughness | |
| # | Composition | (ft-lbs) | (ft-lbs/in²) | (in %) | Observation |
| 1* | Nd₁₆Fe₇₈B₆ | 1.0148 | 12.606 | N/A | Baseline |
| 19 | Nd₁₆Fe_{77.22}Cu_{0.78}B₆ | 1.1559 | 14.359 | 14 | |
| 20 | Nd₁₆Fe_{76.44}Cu_{1.56}B₆ | 1.0751 | 13.355 | 6 | |
| 21 | Nd₁₆Fe_{75 66}Cu_{2 34}B₆ | 0.8838 | 10.979 | −13 | |
| 22 | Nd₁₆Fe_{74 88}Cu_{3 12}B₆ | 0.7426 | 9.225 | −27 | |

*Example #1 is a commercial Nd-Fe-B magnet.

The foregoing establishes that modifying the RE—Fe—B-type magnet compositions with Nb, Cu, and especially Ti, or Nd effectively improves the room temperature toughness of sintered RE—Fe—B-type magnets. Exceptional and unexpected high fracture toughness of 22.124 ft-lbs/in2 and 21.922 ft-lbs/in² were obtained for Nd₁₆Fe_{76.44}Ti_{1.56}B₆ and Nd₁₉Fe₇₅B₆, respectively. These represent a 74 to 76% improvement of the toughness vis-a-vis commercial sintered Nd—Fe—B-type magnets.

It was also found that grain refinement plays an important role in increasing toughness. When grain size is smaller than 25 microns, especially smaller than 12 microns, the fracture toughness increases significantly. We concluded that the smaller the grain size, the better the fracture toughness providing for magnets with the same composition.

Additional minor phases were found in the magnets of the present invention, which has been found to be a very important feature of the invention.

The Nd-rich phases are predominantly along grain boundaries. Some larger Nd-riches phases are also located inside the grains or at the triple grain boundary junctions. These mechanically soft Nd-rich phases help decrease the brittleness, and therefore increase the fracture toughness of the sintered NdFeB magnets of the invention.

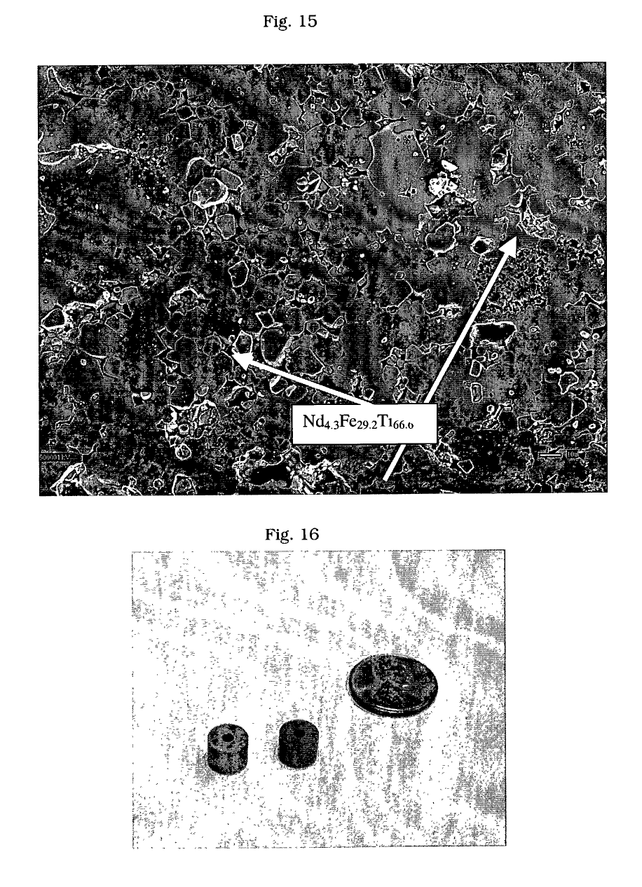

Ti-rich minor phases with a composition close to Nd_{4.3}Fe_{29.2}Ti_{66.5} were identified in the Nd₁₆Fe_{76.44}Ti_{1.56}B₆ sintered magnets of the present invention. These Ti-rich minor phases have excellent toughness due to the amount of transition metals, Fe and Ti, which account for more than 90 atomic percent. The existence of the soft Ti-rich minor phases are the key for the toughness improvement of the Ti added NdFeB magnets of the invention. An example of the microstructure showing the main phase and the Ti-rich minor phases is given in FIG. 15.

By using scanning electron microscope (SEM) and X-Ray analysis, similar minor phases were also identified in the Nb and Cu added NdFeB magnets of the invention. These minor phases generally have low Nd content (<10 atomic %) and high Fe and other transition metal content (>90 atomic %). All these minor TM-rich phases have excellent plasticity and low hardness as compared to the main Nd₂Fe₁₄B phase. The amount and morphology of these minor phases have a great impact to the toughness enhancement of the sintered NdFeB -type magnets of the invention.

As shown in FIG. 16, sintered NdFeB-type magnets of the invention can be machined by conventional cutting and drilling, which is impossible for the commercial sintered NdFeB-type magnets.

The present invention has been described in detail, including the preferred embodiments thereof. However, it will be appreciated that those skilled in the art, upon consideration of the present disclosure, may make modifications and/or improvements on this invention and still be within the scope and spirit of this invention as set forth in the following claims.

What is claimed is:

1. A method of improving the room temperature toughness of sintered RE—Fe—B-type permanent magnets comprising the step of modifying the magnet compositions by adding elements selected from the group consisting of Nb, Cu, Ti, and Nd to the composition before alloying.

2. The method of claim 1, wherein the added element comprises Nb.

3. The method of claim 1, wherein the added element comprises Cu.

4. The method of claim 1, wherein the added element comprises Ti.

5. The method of claim 1, wherein the added element comprises Nd.

6. A method of improving the fracture toughness of sintered RE—Fe—B-type rare earth permanent magnets comprising varying the Nd content in the magnet composition prior to powder metallurgy processing.

7. A method of improving the fracture toughness of sintered RE—Fe—B-type rare earth permanent magnets comprising varying the Nd content in the magnet composition prior to powder metallurgy processing.

8. A method of improving the fracture toughness of sintered RE—Fe—B-type rare earth permanent magnets comprising varying the Nb content in the magnet composition prior to powder metallurgy processing.

9. A method of improving the fracture toughness of sintered RE—Fe—B-type rare earth permanent magnets comprising varying the Cu content in the magnet composition prior to powder metallurgy processing.

10. A method of imparting improved fracture toughness to a class of sintered rare earth permanent magnets comprising modifying the composition of an RE—Fe—B-type permanent magnet to produce a formula selected from the group consisting of:
(a) Nd_{w}Fe_{94-w}B₆, wherein:
w has a value between about 17 and about 22;
(b) Nd₁₆Fe₇₈₋ₓTiₓB₆, wherein:
x has a value between about 0.78 and about 2.34;
(c) Nd₁₆Fe_{78-y}Nb_{y}B₆, wherein:
y has a value between about 1.56 and about 2.34; and
(d) Nd₁₆Fe_{78-z}Cu_{z}B₆, wherein:
z has a value between about 0.78 and about 1.56;
wherein said rare earth permanent magnet maintains high energy product of at least about 30MGOₑ, while showing an improved fracture toughness over conventional sintered Nd—Fe—B rare earth permanent magnets from between about 6% and about 74%.

11. A method of improving machinability of sintered rare earth permanent magnets represented by the general formula, Fe—Fe—B, while maintaining maximum energy product, and improving fracture toughness from between about 6 and 74%; comprising modifying the composition of said magnet, by the addition of substances selected from the group consisting of Nd, Ti, Nb, Cu and mixtures thereof, wherein said addition yields a magnet having a formulation selected from the group consisting of:
(a) Nd_{w}Fe_{94-w}B₆, wherein:
w has a value between about 14 and about 25;
(b) Nd₁₆Fe₇₈₋ₓTiₓB₆, wherein:
x has a value between about 0.02 and about 3.00;
(c) Nd₁₆Fe_{78-y}Nb_{y}B₆, wherein:
y has a value between about 0.02 and about 3.00;
(d) Nd₁₆Fe_{78-z}Cu_{z}B₆, wherein:
z has a value between about 0.02 and about 3.00;
and mixtures thereof.

12. A method for producing of rare earth permanent magnets having the formula:
R₁₀₀₋ₓTMₓA_{y}
with a grain size smaller than 25 microns, wherein R is one or a mixture of rare earths or yttrium, TM is one or a mixture of transition metals, A is one or a mixture of the following elements: Be, B, C, Mg, Al, Si, P, Ga, Ge, As, Se, In, Sn, Sb, Te, I, Pb, and Bi, and x=80-92, y=0-20;
said method comprising the steps of:
(a) prepare a magnetic composition;
(b) melt the composition and form a powder with an average particle size smaller than 5 microns;
(c) press the powder under a magnetic field to obtain green compacts, which are then sintered at from about 1030° C. to 1130° C. and thereafter heat treated at from about 570° C. to 900° C.

13. The method of claim 12, wherein the grain size is smaller than 12 microns.

14. A method for producing rare earth permanent magnets that are consisted of a main phase and one or more minor phases. The composition of the main phase is expressed as:
R₁₀₀₋ₘTMₘAₙ,
where R is one or a mixture of rare earths or yttrium, TM is one or a mixture of transition metals, A is one or a mixture of the following elements: Be, B, C, Mg, Al, Si, P, Ga, Ge, As, Se, In, Sn, Sb, Te, I, Pb, and Bi, and m=75-90, n=0-20; and
the minor phase or phases are rich in transition metal(s) and their composition is expressed as:
R_{100-f}TM_{f}Aᵥ,
where R is one or a mixture of rare earths or yttrium, TM is one or a mixture of transition metals, A is one or a mixture of the following elements: Be, B, C, Mg, Al, Si, P, Ga, Ge, As, Se, In, Sn, Sb, Te, I, Pb, and Bi, and f=85-100, v=0-20;
the total atomic percentage of transition metals, TM, in the minor soft phases is more than 85%;
said method comprising the steps of:
(a) prepare a magnetic composition;
(b) melt the composition to prepare ingots, which are then crushed and milled to powders with an average particle size smaller than 5 microns;
(c) press the powder under a magnetic field to obtain green compacts, which are then sintered at from about 1030° C. to 1130° C., followed by post-sintering heat treatment at from about 570° C. to 900° C.

15. The method of claim 14, wherein the total atomic percentage of transition metals, TM, in the minor soft phases is more than 90%.

16. A method of producing rare earth permanent magnets that possess improved fracture toughness from a compositional change selected from the group consisting of:
(1) the presence of one or more minor phases;
(2) the refinement of grain size;
(3) a combination of both (a) and (b);
said method comprising the steps of:
(a) prepare a magnetic composition;
(b) melt the composition, cool the molten composition and form a powder with an average particle size smaller than 5 microns;
(c) press the powder a magnetic field to obtain green compacts, sinter the green compacts at a temperature of from about 1030° C. to 1130° C., followed by heat treat of the sintered material at a temperature of from about 570° C. to 900° C.

17. A method of producing rare earth permanent magnets that possess fracture toughness equal to or above 15 ft-lbs/in2 at room temperature (20° C.), said method comprising the steps of:
(a) prepare a base magnetic composition;
(b) melt the magnetic composition to form ingots, cool and crush the ingots and mill the crushed ingots into powders with an average particle size smaller than 5 microns;
(c) pressed the powder under a magnetic field to obtain green compacts, and sinter the green compacts at temperature of from about 1030° C. to 1130° C., followed by heat treatment of the sintered material at from about 570° C. to 900° C.
